(19) United States
(12) Patent Application Publication
(10) Pub. No.: US 2024/0033660 A1
(43) Pub. Date: Feb. 1, 2024

(54) A PHASE-SEPARATOR AND AN ASSEMBLY AND METHOD COMPRISING THE SAME

(71) Applicant: AQUESTIA LTD., Ramat Hagolan (IL)

(72) Inventor: Bernd HUSEMANN, Moehmesee (DE)

(21) Appl. No.: 18/021,269

(22) PCT Filed: Aug. 19, 2021
(86) PCT No.: PCT/IL2021/051012

§ 371 Date: Feb. 14, 2023

(30) Foreign Application Priority Data
Aug. 19, 2020 (DE) 20 2020 104 797.3

(51) Int. Cl. B01D 19/00

(52) U.S. Cl. CPC B01D 19/0063; B01D 19/0068

(57) ABSTRACT

The presently disclosed subject matter concerns a gas-purge assembly comprising a phase-separator and a gas-purge valve, for receiving a gas-liquid mixture and intermittently release gas therefrom; said phase-separator comprising a separator tank for accommodating said gas-liquid mixture and facilitate bubbling of gas of the gas-liquid mixture towards an upper portion thereof; and a main port for receiving the gas-liquid mixture from a top portion of an external gas-liquid mixture source disposed therebelow; said gas-purge valve comprising a valve chamber for separately accommodating liquid and gas, said valve chamber having an upper zone in fluid communication with an upper portion of said separator tank, and a lower zone in fluid communication with a lower portion of said separator tank; a venting aperture formed at said upper zone; and a sealing arrangement, configured to intermittently seal and open said venting aperture to enable intermittent release of gas therethrough.

### TECHNOLOGICAL FIELD

The invention relates to a phase-separator for separating gas and liquid from a gas-liquid mixture, an assembly comprising the same and a gas-purge valve, and a method for retrofitting a gas-purge valve to the existing phase-separator.

### BACKGROUND

In a drinking water treatment process, iron and manganese dissolved in raw water are typically removed by oxidation and precipitation. For this purpose, air is blown from below into oxidisers containing the raw water. The supplied air is removed from the oxidisers through an upper part thereof, typically by means of a gas-purge valve connected thereat. Due to decrease in water pressure, air bubbles blown into the oxidiser at the bottom thereof increase in size as they ascend in the water. As gas-purge valves are typically actuated by a float resting on the surface of the water, the operation thereof can be badly affected by the growing air bubbles, as they induce a raging water surface around the float, thereby causing the float to bounce up and down irregularly. Such bouncing can cause a considerable amount of water to leak out of the gas-purge valve, and to an increased wear of the gas-purge valve.

DE 20 2016 102 802 U1 discloses a valve float stabilising barrier with a wall surrounding a space volume and a fastening section by means of which the stabilising barrier is retained in the float chamber of an aeration and ventilation valve in a position which permits functional movement of the float accommodated in the space volume. Such a stabilising barrier can be installed as a retrofit part in the already existing valves or valves can already exhibit such a stabilising barrier from the beginning. Such a stabilising barrier must therefore be geometrically adapted to the relevant valve type and installed in the relevant valve, which is recognisably costly.

### GENERAL DESCRIPTION

The presently disclosed subject matter concerns a gas-purge assembly comprising a phase-separator for separating a gas-liquid mixture, and a gas-purge valve operatively connected to said phase-separator for receiving separated gas of said gas liquid mixture from said phase-separator, and intermittently release said gas;
said phase-separator comprising:
a separator tank having an upper portion and a lower portion, for receiving said gas-liquid mixture therein and facilitate bubbling of gas out of the gas-liquid mixture towards said upper portion; and
a main port formed at said lower portion for receiving said gas-liquid mixture from an external gas-liquid mixture source;
said gas-purge valve comprising:
a valve chamber for accommodating calmed liquid along with gas received from said separator tank, said valve chamber having an upper zone in fluid communication with said upper portion of said separator tank for accommodating said gas received therefrom, and a lower zone in fluid communication with said lower portion of said separator tank for accommodating liquid of said gas-liquid mixture received therefrom;
a venting aperture formed at said upper zone for facilitating releasing of gas therethrough from said upper zone; and
a sealing arrangement, configured to intermittently seal and unseal said venting aperture to enable intermittent release of gas therethrough.

According to yet another aspect of the presently disclosed subject matter, there is provided a phase-separator for separating a gas-liquid mixture, operable in conjunction with a gas-purge valve for providing separated gas of said gas liquid mixture to said gas-purge valve, the phase-separator comprising:
a separator tank having an upper portion and a lower portion, for receiving said gas-liquid mixture therein and facilitate bubbling of gas out from the gas-liquid mixture towards said upper portion;
a main port formed at said lower portion for receiving said gas-liquid mixture;
a separator gas port formed at said upper portion for enabling extraction of said gas from said upper portion into an upper zone of said gas-purge valve;
a separator liquid port formed at said lower portion for enabling extraction of liquid of said gas-liquid mixture from said lower portion to a lower zone of said gas-purge valve; and
a separating barrier extending from an inner wall of said lower portion between said main port and said separator liquid port, above a lowermost end of the separator liquid port so as to direct said bubbling gas away from the separator liquid port yet enable liquid to enter therethrough.

According to yet another aspect of the presently disclosed subject matter, there is provided a method for retrofitting a phase-separator to a gas-purge valve having a calmed-liquid valve chamber with an upper zone for accommodating gas, and a lower zone for accommodating liquid; said method comprising steps of:
providing a phase-separator having a separator tank with an upper portion and a lower portion, said separator tank being configured for receiving said gas-liquid mixture therein and facilitate bubbling of gas out of the gas-liquid mixture towards said upper portion;
establishing fluid communication between said upper zone and said upper portion for enabling gas to pass therebetween; and
establishing fluid communication between said lower zone and said lower portion for enabling liquid to pass therebetween, thereby achieving a communicating vessels relation between the separator tank and the valve chamber.

Any one or more of the following features, designs, and configurations can be implemented in any one or more of said phase-separator, said gas-purge assembly, and said method, independently or in combination with other respective features.

It should be appreciated that said gas-purge valve can be equivalent to any known in the art valve configured to receive a gas-liquid mixture, and facilitate intermittent release of gas from said gas-liquid mixture, e.g., an aeration and ventilation valve, an air valve, etc.

The main port can comprise means for sealingly connecting to an external fluid source, e.g., an oxidation and precipitation tank, a fluid line, etc.

According to an example, the main port is formed at a lower portion, i.e., a floor, of the separator tank.

As can be understood, the separator tank and the valve chamber are connected as communicating vessels, rendering the liquid levels therein substantially equal. In addition, both the separator tank and the valve chamber are sealed at their top, which renders the pressure level of the gas accommodated thereby at the upper zone and upper portion also substantially equal, and depend on the amount of bubbles released from the gas liquid mixture into the upper portion of the tank.

As the main port is positioned at the lower portion of the separator tank, when gas-liquid mixture is received therethrough, gas bubbles from the gas liquid mixture bubble up the tank to the upper portion thereof, leaving gas-free liquid at the lower portion thereof.

The gas-free liquid enters the lower zone of the valve chamber by means enabling the fluid communication between the lower zone and the lower portion, e.g., corresponding ports connected either directly or through an appropriate piping system, while gas enters the upper portion of the valve chamber by similar means.

While liquid level at the separator tank is unstable due to the bubbling of gas therein, having gas-free liquid entering the valve chamber facilitates a calmed liquid level therein. Such calmed liquid level can be beneficial for preventing liquid splashes from exiting the venting aperture, and for enabling utilization, and reduction of tear, of an actuating member effected by the intensity of liquid within the gas-purge valve, i.e., a floating actuator, or otherwise referred to a float.

According to an example of the presently disclosed subject matter, the sealing arrangement includes a sealing member in the form of a movable barrier, and an axially displaceable float, both accommodated within the valve chamber. The float being operatively connected to said sealing member such that said movements of the sealing member are actuated by movements of said float, e.g., when the float is at an upper position the sealing member seals the venting aperture, and when the float is at a lower position, the sealing member opens the venting aperture. The float's position is determined by the water level within the valve chamber.

During operation of the assembly, when liquid level at the valve chamber is sufficient, the float is at its upper position, and the venting aperture is sealed by the sealing member. When a sufficient amount of gas bubbles leave the gas liquid mixture and accumulate at the top portion of the tank and at the top zone of the chamber, gas pressure rises in both the tank and the chamber, thereby lowering the liquid level therein. When liquid level is low enough, the float axially displaces downwards to its lower position, and the venting aperture opens by the sealing member. The open venting aperture allows the accumulated gas to leave the valve chamber, thereby causing the level of liquid therein to rise again and bring the float to its upper position.

According to an example of the presently disclosed subject matter, the gas-purge assembly can be connected to an upper portion of an oxidation and precipitation tank, for receiving a gas-liquid mixture of water and air therefrom. Particularly, the gas-purge assembly can be connected to an upper portion of the oxidation and precipitation tank, such that when said tank is filled with liquid to maximum, this liquid rises within the assembly, and replaces air accommodated therewithin. The replacement of air can be facilitated only when the venting aperture is open and enabling the air to leave the assembly. When liquid level within the assembly rises to a certain extent, the float rises and closes the venting aperture. When gas is introduced into the oxidation and precipitation tank, it rises and fills an upper volume of the assembly, thereby causing the float to lower down and the venting aperture to reopen and enable the gas accumulated in the upper volume to be released from the assembly. The leaving gas allows the liquid level within the assembly to rise again, along with the float, and seal the venting aperture once more. This process repeats throughout the operation of the oxidation and precipitation tank.

The means for facilitating fluid communication between the valve chamber and the separator tank can include a separator liquid port formed at said lower portion, a separator gas port formed at said upper portion, a valve liquid port formed at said lower zone, and a valve gas port formed at said upper zone. The corresponding upper and lower ports can be connected directly to one another, or the gas-purge assembly can further comprise a liquid passageway extending between said separator liquid port and said valve liquid port for facilitating passage of the liquid therebetween, and a gas passageway extending between said separator gas port and said valve gas port for facilitating passage of the gas therebetween. The liquid passageway and the gas passageway should be such which together can establish a communicating vessels relation between said separator tank and said valve chamber.

To prevent gas bubbles from entering the separator liquid port, the phase-separator can further comprise separating barrier extending within said separator tank, between said main port and said separator liquid port, above a lowermost end of the separator liquid port. According to some examples, the separating barrier can extend above a central flow axis of said separator liquid port, i.e., above half of the liquid port, and particularly above a highermost end of the liquid port, i.e., above the entire liquid port. As gas bubbles typically move upwards, the separating barrier can direct them away from the liquid port yet enable liquid to enter therethrough.

The wall can be a in the form of a flange extending from a floor of said tank, or from a sidewall of said tank, concealing the liquid port, or in the form of a cylinder extending around and above the main port.

It should be appreciated that despite its name, the gas-free liquid entering the liquid port can contain some amount of gas, as the separation of the gas from the liquid is performed spontaneously in the separator tank. However, the amount of gas should be such which maintains a considerably calmer level of liquid within the valve chamber, than in the separator tank. To prevent gas from accumulating in the passage between the separator liquid port and the valve liquid port, a liquid passageway defined by both should be smooth and in an upward direction.

It should further be appreciated that the entire assembly can facilitate complete emptying of the liquid/gas-liquid mixture through the main port. To facilitate such, the separator liquid port and the separator gas port can be designed to enable bi-directional flow of liquid and gas therethrough, respectively.

The emptying can be performed gravitationally, when the entire assembly is vented, e.g., by opening the venting aperture and stop introduction of liquid into the separator tank through the main port, e.g., by lowering liquid pressure in the oxidation and precipitation tank when the assembly is connected thereto. During such emptying, the liquid and gas-water mixture, accommodated in the valve chamber and in the separator tank, gravitationally drain through the main port back to their original accommodation vessel of the gas-liquid mixture, e.g., the oxidation and precipitation tank.

To enable liquid to gravitationally drain from the valve chamber into the valve liquid port, the valve liquid port can be positioned at a lowermost area of the valve liquid port, and optionally be formed on a floor thereof.

To enable liquid to gravitationally drain from the valve chamber to the separator tank, the separator liquid port can be positioned below the valve liquid port.

To enable water to gravitationally drain from the separator tank through the main port, the main port can be positioned at a lowermost area of the separator tank, optionally to be formed on a floor thereof, and particularly, below the separator liquid port.

To prevent liquid from being trapped in an area of the separator tank between the separation wall and a sidewall of the separator tank, the separating barrier can be designed to enable return of liquid from said separator liquid port to said main port, below a highermost end of the wall.

According to an example of the presently disclosed subject matter, the separating barrier comprises a return opening formed at a bottommost portion thereof, configured to facilitate return of trapped liquid to the main port.

To prevent air bubbles from entering through the return port into the separator liquid port, the separating barrier can be angled such that a return surface thereof faces away from the separator liquid port, and the return port can be formed at that return surface. Optionally, the separating barrier encloses an area in front of one of said separator liquid port and said main port.

To facilitate comfortable connection to an adjacent air-purge valve, the separator liquid port, and optionally, the separator gas port, can be formed in a side wall, optionally the same side wall, of said separator tank. Correspondingly, the valve gas port, and optionally the valve liquid port, can be formed in a sidewall, optionally the same side wall, of said valve chamber.

According to an example of the presently disclosed subject matter, the separator gas port and the separator liquid port are substantially aligned along a vertical axis extending across the respective sidewall of the separator tank.

The separator tank can be elongated.

The valve chamber can also be elongated.

To prevent liquid from splashing into the separator gas port, the phase-separator can further comprise a splash guard disposed within the separator tank, normally facing, and spaced apart from said separator gas port, so as to inhibit splashes of liquid from entering the separator gas port.

The splash guard can have an effective splash blocking area which is greater than a cross-sectional area of said separator gas port.

It should be appreciated that the phase-separator can be compatible for retrofitting with the gas-purge valve. To facilitate such, the separator gas port and the separator liquid port can comprise means for sealingly connecting to a corresponding liquid and gas ports of the gas-purge valve.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A illustrates a gas-purge assembly according to one example of the presently disclosed subject matter;

FIG. 1B is a schematic illustration of a cross-sectional view of the gas-purge assembly of FIG. 1A;

FIG. 1C is a schematic illustration of a cross-sectional view of a gas-purge valve according to prior-art;

FIG. 1D illustrates a cross-sectional view of an oxidation and precipitation tank with the gas-purge valve of FIG. 1C

FIG. 2 illustrates the gas-purge assembly of FIG. 1B, in operation;

FIG. 3 illustrates the gas-purge assembly of FIG. 1B, during emptying thereof;

FIG. 4 is a cross-sectional view of an oxidation and precipitation tank with the gas-purge assembly of FIG. 1B connected to a ceiling thereof;

FIG. 5 is a cross-sectional view of a gas-purge assembly according to another example of the presently disclosed subject matter; and

FIG. 6 illustrates a method for retrofitting a gas-purge valve with a phase-separator to form a gas-purge assembly.

### DETAILED DESCRIPTION OF EMBODIMENTS

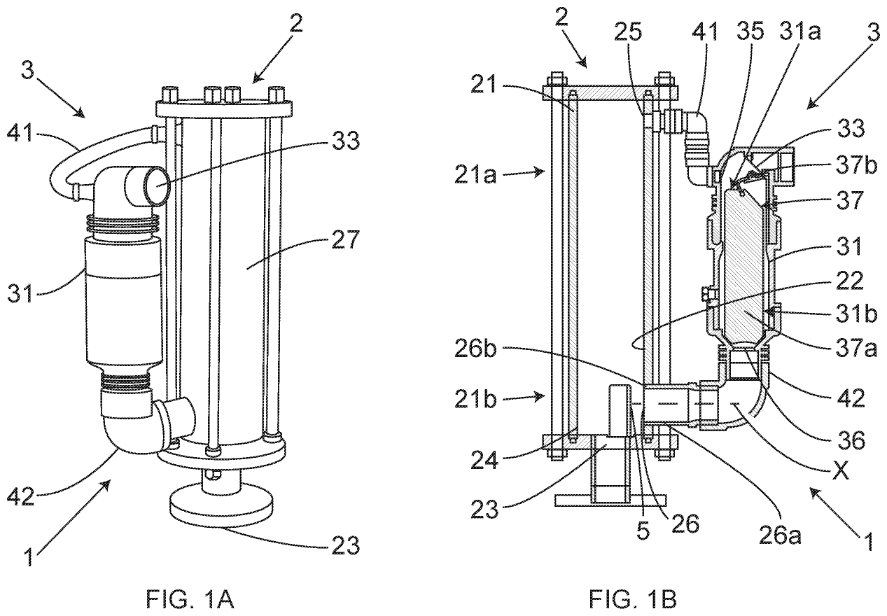

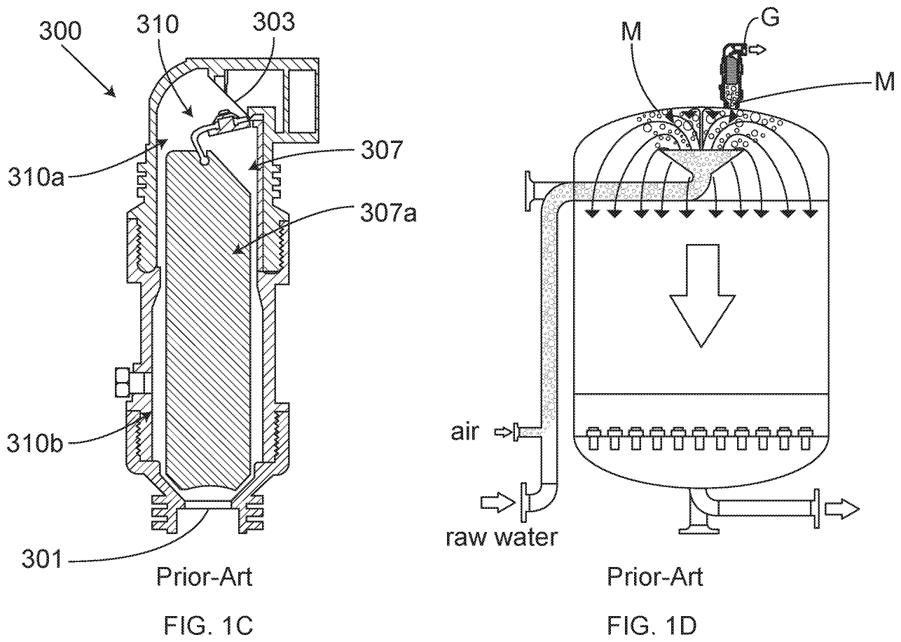

Attention is first directed to FIGS. 1A and 1B illustrating a gas-purge assembly 1 according to one example of the presently disclosed subject matter. The gas-purge assembly 1 is operable to receive a gas-liquid mixture M, separate the gas-liquid mixture into gas G and liquid L, and release the gas G, optionally to ambient environment.

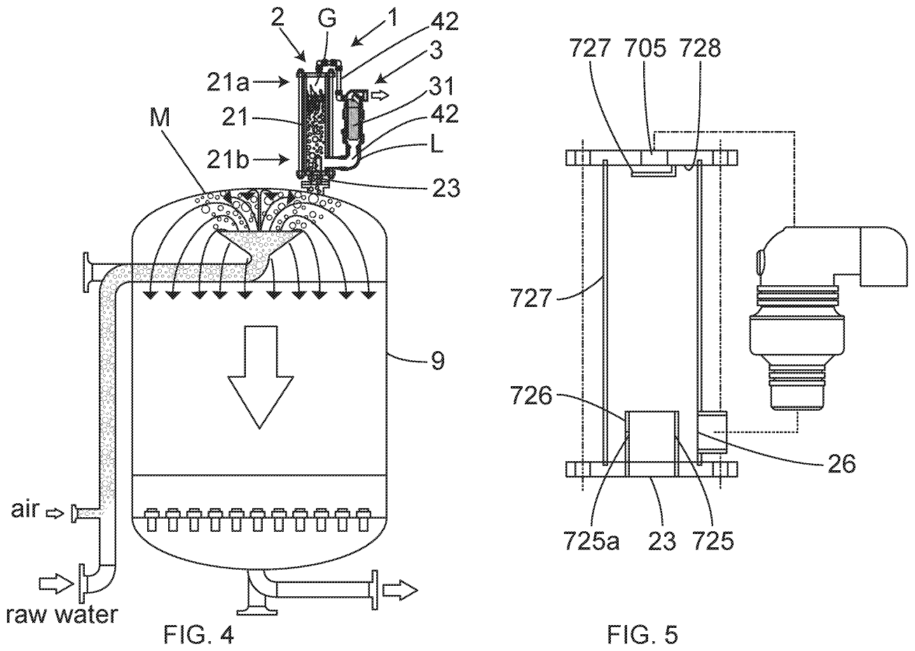

The assembly 1 can be fitted to an external gas-liquid mixture source, such as oxidation and precipitation tank 9 as seen in FIG. 4, and is designed to ensure the release of air or other gasses trapped therein. It is appreciated that the oxidation and precipitation tank 9 is only one example of an external source of gas-liquid mixture M, to which the assembly is connectable. Other sources can be for example, a fluid line with a gas-liquid mixture M.

In the course of normal operation of the oxidation and precipitation tank 9, with constant flow of air and raw water thereinto, as illustrated in FIG. 4, the assembly 1 fills with water containing air-bubbles originated from the precipitation tank 9, i.e., a gas-liquid mixture M, facilitates the release of the gas, i.e., the air, of the gas-liquid mixture to external ambient, and facilitates return of liquid L, i.e., water, back into the tank 9.

To facilitate the release of gas, the assembly 1 comprises a gas-purge valve 3, which in the examples presented herein is of an automatic, float-actuated type.

The gas-purge valve 3 is provided with a valve chamber 31 formed with a venting aperture 33 at an upper zone 31a thereof for facilitating release of gas therethrough, and a sealing arrangement 37 in the form of a flexible closure membrane 37b operatively connected to an axially displaceable float 37a. The float 37a is movable up and down within the valve chamber 31, to intermittently bring the flexible membrane 35b into, and out from, sealing engagement with the venting aperture 33, to enable intermittent release of gas therethrough.

The gas-purge assembly 1 can be connected to an upper portion of the oxidation and precipitation tank 9, when the latter is empty, with the venting aperture 33 open as the float 37a is at its lower position due to lack of water therein. When the oxidation and precipitation tank 9 is filled with liquid to maximum, this liquid rises within the assembly, and replaces air accommodated therewithin, which leaves the assembly 1 through the aperture 33. When liquid level within the assembly rises to a certain extent, the float 37a rises and closes the venting aperture 33. When gas is introduced into the oxidation and precipitation tank 9, it rises and fills an upper volume of the assembly 1, i.e., particularly, the upper zone 31a of the valve chamber 31, thereby causing the float 37a to lower down and open the venting aperture 33, thereby enabling some gas accumulated in the upper volume to be released from the assembly 1. The leaving gas allows the liquid level within the assembly 1 to rise again, along with the float 37a, which seals the venting aperture 33 once more. This process repeats throughout the operation of the oxidation and precipitation tank 9, i.e., the venting aperture 33 opens intermittently.

As known in the art, and as seen in FIG. 1C, gas-purge valves similar to the gas-purge valve 3, can be connected directly to an upper portion of an oxidation and precipitation tank 9, or any other external source of gas-liquid mixture M for that matter. Such gas-purge valves, e.g., gas-purge valve 300 seen in FIG. 1D, are typically provided with a single port 301 at their bottom for receiving therethrough the gas-liquid mixture M directly from the oxidation and precipitation tank 9, facilitate bubbling of the gas out of the gas-liquid mixture in their valve chamber 310, and release the gas G to external ambient as described above.

Liquid mixed with gas bubbles typically induce an unstable, i.e., turbulent, liquid surface in the valve chamber 310, which would cause the float 307a to bounce up and down irregularly, thereby speeding up wear processes of the entire sealing arrangement 307. Such bouncing would also cause splashes of liquid L to pass through the venting aperture 303.

To calm liquid surface within the gas-purge valve 3, namely within the valve chamber 31, it is desired to keep liquid containing a substantial amount of gas bubbles from entering thereto. To facilitate such, the assembly 1 further comprises a phase-separator 2 ensuring a calmed liquid level within the valve chamber 31.

The phase-separator 2 is configured to be the first in line to receive the gas-liquid mixture M from the external gas-liquid mixture source, separate the gas G from the liquid L in the mixture, and provide the gas G and the gas-free liquid L separately to the valve chamber 31, namely, provide the gas G above the liquid L accommodated in the valve chamber 31, so it will not bubble within the liquid L.

The gas-free liquid L can facilitate a calm liquid level within the valve chamber 31, and thus can contribute to smoother operation and reduced wear of the sealing arrangement 37, and particularly the float 37a.

The phase-separator 2 comprises a separator tank 21 for receiving the gas-liquid mixture M, formed with a main port 23 at a lower portion 21b thereof for fluidly connecting the separator tank 21 to the external gas-liquid mixture source, e.g., oxidation and precipitation tank 9.

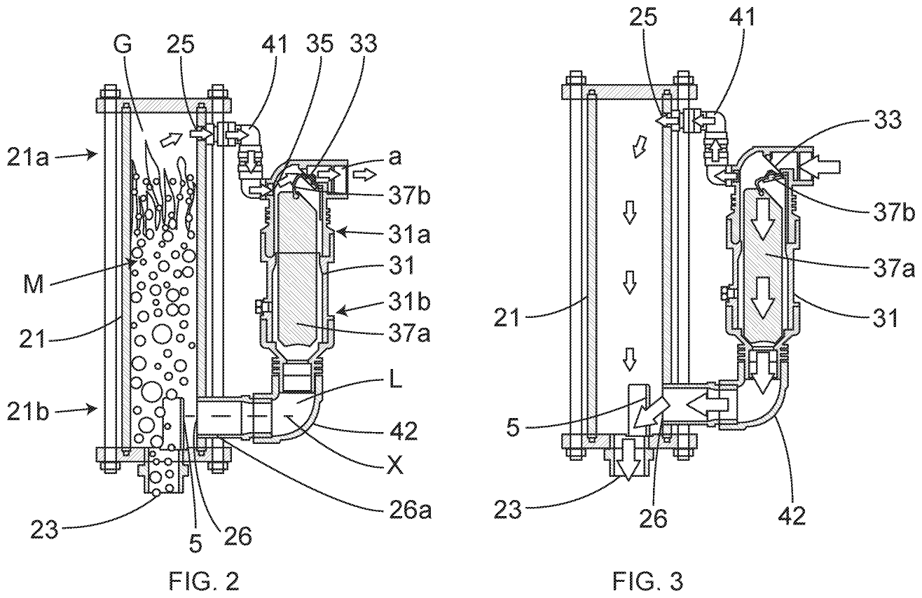

The separator tank 21 is configured to receive the gas-liquid mixture M through the main port 23, facilitate bubbling of gas G out of the gas-liquid mixture M from the lower portion 21b towards an upper portion 21a thereof, as seen in FIG. 2, and facilitate the return of liquid L through the main port 23. As can be seen in FIGS. 1A and 1B, a volume of the separator tank 21 can be grater than a volume of the valve chamber 31 to enable a greater space for said bubbling of gas G.

As can be understood, the main port 21 is bi-directional to be able to facilitate both receiving of the gas-liquid mixture M, and the return of liquid L.

To facilitate the calmed liquid level at the valve chamber 31, the gas-purge valve 3 is connected at a side of the separator tank 21, a little higher than a floor 24 thereof, with the lower portion 21b of the separator tank 21 connected in fluid communication with lower zone 31b of the valve chamber 31.

As air bubbles typically move upwards, a side-by-side arrangement of the phase-separator 2 and the gas-purge valve 3 enables passage of gas-free liquid L from the lower portion 21b to the lower zone 31b substantially in a horizontal direction, thereby preventing passage of ascending gas bubbles therethrough.

Further, the upper portion 21a of the separator tank 21 is connected in fluid communication with the upper zone 31a of the valve chamber 31 to enable passage of gas therebetween.

With such configuration, the separator tank 21 and the valve chamber 31 de-facto share a communicating vessels relation allowing the valve chamber 31 to be filled with gas-free liquid L even when the venting aperture 33 is closed.

As the valve chamber 31 and the separator chamber 21 share a communicating vessels relation, the liquid level in each of which remains the same in average, only that liquid level in the main tank 21 is raging due to the bubbling of the gas G therein, while liquid level in the valve chamber 31 is relatively stable, i.e., calmed, as substantially less bubbling of gas occurs therein, and optionally, no bubbling at all.

It should be appreciated that the fluid communication of the upper portion 21a and the upper zone 31a can be facilitated by means of a gas passageway, e.g., pipe 41 fluidly connecting a separator gas port 25 of the separator tank 21 with a valve gas port 35 of the valve chamber 21, while the fluid communication of the lower portion 21b and the lower zone 31b can be facilitated by a liquid passageway, e.g., pipe 42 fluidly connecting a separator liquid port 26 of the separator tank 21 with a valve liquid port 36 of the valve chamber 31.

To prevent gas bubbles from entering the separator liquid port 26, the separator liquid port 26 is formed on the lower portion 21b of the separator tank 21, in a sidewall 22 thereof spaced from the main port 23. As gas bubbles tend to float upwards, they avoid the separator liquid port 26 on there way from the lower portion 21b to the upper portion 21a of the separator tank 21. To keep those gas bubbles which did got in through the separator liquid port 26, an upper wall thereof can be angled in an upward direction towards the upper portion of the separator tank 21, thus defining an upward path therefore.

To further prevent gas bubbles from entering the separator liquid port 26, the separator tank 21 can be provided with a separating barrier 5 extending from an inner wall of the lower portion 21b, between the main port 23 and the separator liquid port 26. When gas bubbles enter through the main port 23 into the separator tank 21, the separating barrier 5 directs them away from the separator liquid port 26, yet enable gas-free liquid accumulated in the lower portion 21b to pass and reach the separator liquid port 26.

To effectively direct bubbles away from the separator liquid port 26, the separating barrier 5 can extend above a lowermost end 26a of the separator liquid port 26. According to some examples, the separating barrier 5 can extend above a central flow axis X of the separator liquid port 26, i.e., above half of the separator liquid port 26, and particularly above a highermost end 26b of the separator liquid port 26, i.e., above the entire separator liquid port 26.

The separating barrier 5 seen in FIGS. 1 to 3 herein, is in the form of a flange extending from a floor 24 of the separator tank 21.

It should be appreciated that despite its name, the gas-free liquid entering the separator liquid port 26 can contain some amount of gas, as the separation of the gas from the liquid in the separator tank 21 is performed spontaneously. However, the amount of gas should be such which maintains a considerably calmer level of liquid within the valve chamber 31, than in the separator tank 21.

To prevent gas still present in the liquid from accumulating in the pipe 42, the pipe 42 is formed smoothly and only includes upwardly angled corners.

It should further be appreciated that the entire assembly 1 can facilitate complete emptying of the liquid/gas-liquid mixture through the main port 23, e.g., when it is desired to empty the external gas-liquid mixture source.

As seen in FIG. 3, the emptying can be performed gravitationally, when the entire assembly is vented, e.g., by opening the venting aperture 33. During such emptying, the gas G leaves the assembly 1 through the venting aperture and the liquid L stored in the valve chamber 31 and separator tank 21 gravitationally drain through the main port 23 back to its original accommodation vessel, e.g., oxidation and precipitation tank 9.

To enable the liquid L to gravitationally drain from the valve chamber 31 into the valve liquid port 36, the valve liquid port 36 can be positioned at a lowermost area of the valve chamber 31, and optionally be formed at a floor thereof.

To enable the liquid L to gravitationally drain from the valve chamber to the separator tank 21, the separator liquid port 26 can be positioned below the valve liquid port 36. As mentioned hereinabove, the pipe 42 connecting the two ports is smooth and designed in a general upward orientation, thereby eliminating a possible siphon effect from taking place during said emptying.

To enable the liquid L to gravitationally drain from the separator tank 21 through the main port 23, the main port can be formed at a lowermost area of the separator tank 21, and particularly, on a floor thereof, below the separator liquid port 26.

To prevent liquid from being trapped in an area of the separator tank 21 between the separating barrier 5 and a sidewall of the separator tank 21, the separating barrier 5 can be designed to enable return of liquid from said separator liquid port to said main port, below a highermost end thereofa.

Although not illustrated, it should be appreciated that the separating barrier 5 of the assembly 1 is levelled at a lowermost end thereof, and extends only partially between the sidewalls of the separator tank 21, such that a gap remains on at least one side thereof, between the wall 5 and a sidewall of the separator tank 21. Through that gap liquid can return from the separator liquid port 26 into the main port 23.

FIG. 5 illustrates a gas-purge assembly 100 according to another example of the presently disclosed subject matter. The gas purge assembly 100 comprises the gas-purge valve 3, and a phase-separator 120 sharing the same features with the phase-separator 2, only with a separating barrier 105 being different than the separating barrier 5, and separator gas port 125 being different than the separator gas port 25, as will be explained hereinafter.

As seen in FIG. 5, the separating barrier 125 encloses an area within the separator tank 121, in front of the main port 23, and comprises a return port 125a via which liquid can return from beyond the barrier 125 into the main port 23 during emptying of the assembly 100.

To prevent gas bubbles from reaching the separator liquid port 26 through the return port 125a, the separating barrier is angled, particularly cylindrical, such that a return surface 126 thereof, in which the return port 125 is formed, faces away from the separator liquid port 26.

To facilitate proper drainage beyond the separating barrier 125, the return port extends from a lowermost end of the barrier 125.

To prevent liquid from splashing into the separator gas port 105, the separator gas port 105 is formed on a ceiling 128 of the separator tank 121. To further prevent said splashes, the phase-separator 121 includes a splash guard 127 disposed within the separator tank 121, normally facing, and just a little spaced apart from said separator gas port 125, so as to inhibit splashes of liquid from entering the separator gas port 125.

As seen in FIG. 5, the splash guard 127 has an effective splash blocking area which is greater than a cross-sectional area of the separator gas port 125.

As there are existing gas-purge valves, e.g., the gas purge valve 300 illustrated in FIG. 1D, which were not originally designed to work in conjunction with a phase-separator, it can be desired to retrofit an existing gas-purge valve with a phase-separator such as the phase separator 2, to form a gas-purge assembly according to the presently disclosed subject matter.

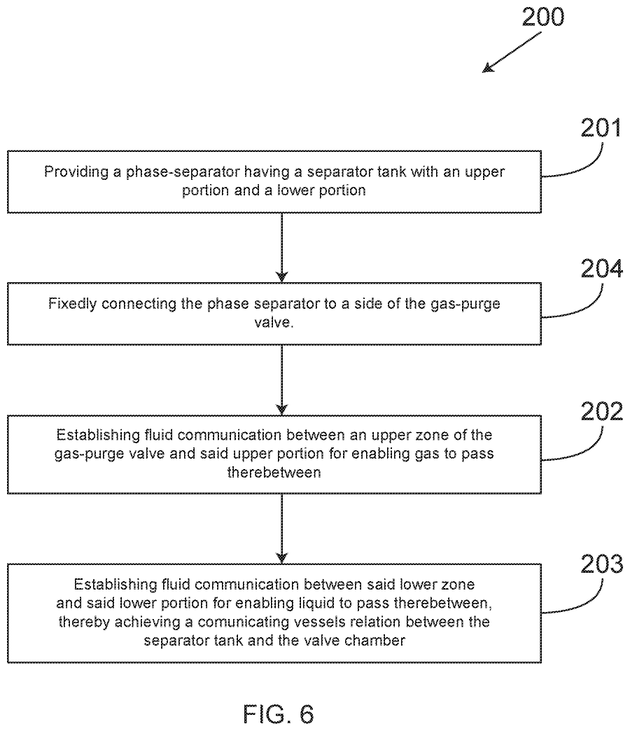

FIG. 6 illustrates a method 200 for retrofitting an existing gas-purge valve, as the gas-purge valve 300, with a phase-separator, as the phase-separator 2, 120, to form a gas-purge assembly, as the gas-purge assembly 1.

The method 200 comprises a step 201 of providing a phase-separator, such as the phase-separator 2.

The method 200 further comprises a step 202 of establishing fluid communication between an upper zone 310a of the gas-purge valve 300 and the upper portion 21a of the phase-separator 2 for enabling gas G to pass therebetween. Such establishment of fluid communication may include forming a valve gas port, as the valve gas port 35, in the upper zone 310a of the valve 300.

The method 200 further comprises a step 203 of establishing fluid communication between a lower zone 310b of the gas purge valve 300 and the lower portion 21b of the phase-separator 2, for enabling liquid L to pass therebetween, and thereby facilitate a communicating vessels relation between the phase-separator 2 and the gas-purge valve 300. Such establishment may be performed such that the port 301 of the valve 300 is higher than the separator liquid port 26, to facilitate gravitational emptying of the valve 300.

The method can further include an intermediate step 204 of fixedly connecting the phase-separator 2 to a side of the gas-purge valve 300, such that the liquid passing therebetween passes substantially in a horizontal direction, thereby preventing gas bubbles from entering the gas-purge valve 300.

1-44. (canceled)

45. A gas-purge assembly, comprising:
a phase-separator for separating a gas-liquid mixture; and
a gas-purge valve operatively connected to said phase-separator for receiving separated gas of said gas liquid mixture from said phase-separator, and intermittently release said gas;
wherein said phase-separator includes:
a separator tank having an upper portion and a lower portion, for accommodating said gas-liquid mixture and facilitate bubbling of gas of the gas-liquid mixture towards said upper portion; and
a main port formed at said lower portion for receiving said gas-liquid mixture from a top portion of an external gas-liquid mixture source disposed therebelow;
wherein said gas-purge valve includes:
a valve chamber for separately accommodating liquid and gas received from said separator tank, said valve chamber having an upper zone in fluid communication with said upper portion of said separator tank, and a lower zone in fluid communication with said lower portion of said separator tank;
a venting aperture formed at said upper zone for facilitating releasing of gas therethrough from said upper zone; and
a sealing arrangement, configured to intermittently seal and open said venting aperture to enable intermittent release of gas therethrough.

46. The gas-purge assembly of claim 45, wherein said sealing arrangement comprises an axially displaceable float and a sealing member, said float being operatively connected to said sealing member such movements of the float cause the sealing member to be brought into and out from sealing engagement with said venting aperture.

47. The gas-purge assembly of claim 45, wherein said sealing member is a displaceable barrier secured at said upper zone, in the area of said venting aperture.

48. The gas-purge assembly of claim 45, wherein:
said phase-separator further includes a separator liquid port formed at said lower portion, and a separator gas port formed at said upper portion; and
said gas-purge valve further includes a valve liquid port formed at said lower zone, and a valve gas port formed at said upper zone; and
said gas-purge assembly further includes a liquid passageway extending between said separator liquid port and said valve liquid port for facilitating passage of the liquid therebetween, and a gas passageway extending between said separator gas port and said valve gas port for facilitating passage of the gas therebetween; wherein said liquid passageway and said gas passageway together establish a communicating vessels relation between said separator tank and said valve chamber.

49. The gas-purge assembly of claim 48, wherein said phase-separator further includes a separating barrier extending within said separator tank, between said main port and said separator liquid port, above a lowermost end of the separator liquid port, for directing said gas bubbles away from said separator liquid port yet enable liquid to enter therethrough.

50. The gas-purge assembly of claim 49, wherein said separating barrier extends above a central flow axis of said separator liquid port, and particularly above a highermost end of said separator liquid port.

51. The gas-purge assembly of claim 49, wherein said separating barrier is designed to enable return of liquid from said separator liquid port to said main port, below a highermost end of said wall.

52. The gas-purge assembly of claim 49, wherein said separating barrier includes a return opening formed at a bottommost portion thereof, configured to facilitate return of trapped liquid to the main port.

53. The gas-purge assembly of claim 49, wherein said separating barrier encloses an area in front of one of said separator liquid port and said main port.

54. The gas-purge assembly of claim 45, wherein said separator liquid port and said valve liquid port are positioned below said separator gas port and said valve gas port.

55. A phase-separator for separating a gas-liquid mixture, operable in conjunction with a gas-purge valve for providing separated gas of said gas liquid mixture to said gas-purge valve, the phase-separator comprising:
a separator tank having an upper portion and a lower portion, for accommodating said gas-liquid mixture and facilitate bubbling of gas of the gas-liquid mixture towards said upper portion;
a main port formed at said lower portion for receiving said gas-liquid mixture;
a separator gas port formed at said upper portion for enabling extraction of said gas from said upper portion into an upper zone of said gas-purge valve;
a separator liquid port formed at said lower portion for enabling extraction of liquid of said gas-liquid mixture from said lower portion to a lower zone of said gas-purge valve; and
a separating barrier extending from an inner wall of said lower portion between said main port and said separator liquid port, above a lowermost end of the separator liquid port so as to direct said bubbling gas away from the separator liquid port yet enable liquid to enter therethrough.

56. The phase-separator of claim 55, wherein said separating barrier extends above a central flow axis of said separator liquid port, and particularly above a highermost end of said separator liquid port.

57. The phase-separator of claim 55, wherein said separating barrier is designed to facilitate return of liquid from said separator liquid port to said main port, beneath a highermost end of said separating barrier.

58. The phase-separator of claim 55, wherein said separating barrier includes a return port formed at a bottommost portion thereof.

59. The phase-separator of claim 55, wherein said separating barrier encloses an area in front of one of said separator liquid port and said main port.

60. The phase-separator of claim 55, wherein said main port is positioned below said separator liquid port.

61. A method for retrofitting a phase-separator to a gas-purge valve having a valve chamber with an upper zone for accommodating gas, and a lower zone for accommodating liquid, to form a gas-purge assembly; said method comprising:
(i) providing a phase-separator having a separator tank with an upper portion and a lower portion, said separator tank being configured for accommodating said gas-liquid mixture and facilitate bubbling of gas out of the gas-liquid mixture towards said upper portion;
(ii) establishing fluid communication between said upper zone and said upper portion for enabling gas to pass therebetween; and
(iii) establishing fluid communication between said lower zone and said lower portion for enabling liquid to pass therebetween, thereby achieving a communicating vessels relation between the separator tank and the valve chamber.

62. The method of claim 61, further comprising an intermediate step of fixedly connecting the phase-separator to a side of the gas-purge valve such that the liquid passing therebetween passes substantially in a horizontal direction.

63. The method of claim 61, wherein step (ii) further includes forming a valve gas port at said upper zone, via which said fluid communication is established.

64. The method of claim 63, wherein at step (iii) said fluid communication is established between a valve liquid port of said gas-purge valve and a separator liquid port of said phase-separator, and wherein said fix connection between the gas-purge valve and the phase-separator is performed such that the separator liquid port is disposed below the valve liquid port.
